(19) United States
(12) Patent Application Publication
(10) Pub. No.: US 2008/0180632 A1
(43) Pub. Date: Jul. 31, 2008

(54) Lens/frame combination for glasses

(76) Inventor: Chih-Ming Chen, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/698,903

(22) Filed: Jan. 29, 2007

(51) Int. Cl. G02C 1/04; G02C 1/00; G02C 1/06

(52) U.S. Cl. 351/83; 351/41; 351/103

(57) ABSTRACT

A lens/frame combination for a pair of glasses includes a frame and at least one lens made of a material different from that of the frame. The frame includes at least one receiving portion having a coupling groove for coupling with the at least one lens. The at least one lens includes a peripheral edge that is at least partially and securely coupled with the coupling groove of the frame, forming a jointing area therebetween. The peripheral edge of the at least one lens is received in the coupling groove of the at least one receiving portion to a depth of 0.7 mm-5.0 mm, preferably 0.9 mm-5.0 mm.

### BACKGROUND OF THE INVENTION

1. Field of the Invention

The present invention relates to a lens/frame combination for a pair of glasses.

2. Description of the Related Art

FIG. 1 illustrates a pair of conventional glasses 1 including a frame 12 and two lenses 11 received in two holes in the frame 12. Each lens 11 is usually made of glass or plastics and has an outer diameter greater than an inner diameter of an associated hole. Namely, the lenses 11 are forcibly inserted into the holes. Thus, the lenses 11 are liable to disengage from the frame 12 when the frame 12 is subject to an external force or impact, which may cause injury to the face or eyes of the user.

The present invention is intended to provide a pair of glasses that mitigates and/or obviates the above-mentioned problem.

### SUMMARY OF THE INVENTION

A lens/frame combination for a pair of glasses in accordance with the present invention includes a frame and at least one lens made of a material different from that of the frame. The frame includes at least one receiving portion having a coupling groove for coupling with the at least one lens. The at least one lens includes a peripheral edge that is at least partially and securely coupled with the coupling groove of the frame, forming a jointing area therebetween. The peripheral edge of the at least one lens is received in the coupling groove of the at least one receiving portion to a depth of 0.7 mm-5.0 mm, preferably 0.9 mm-5.0 mm.

In a preferred form, the combination includes a frame having two receiving portions and two lenses respectively received. In an example, the peripheral edge of each lens is completely coupled with the coupling groove of an associated receiving portion of the frame. In another example, the peripheral edge of each lens includes an upper portion coupled with the coupling groove of an associated receiving portion of the frame.

The lenses are securely bonded with the frame, providing reliable engagement and preventing the lenses from disengaging from the frame. Furthermore, the engaging depth between the peripheral edge of each lens and the associated coupling groove of the frame is not deep such that the material cost of the lenses can be cut and that the frame will not be too stiff, providing comfortable contact with the user's face.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view, partially exploded, of a pair of conventional glasses.

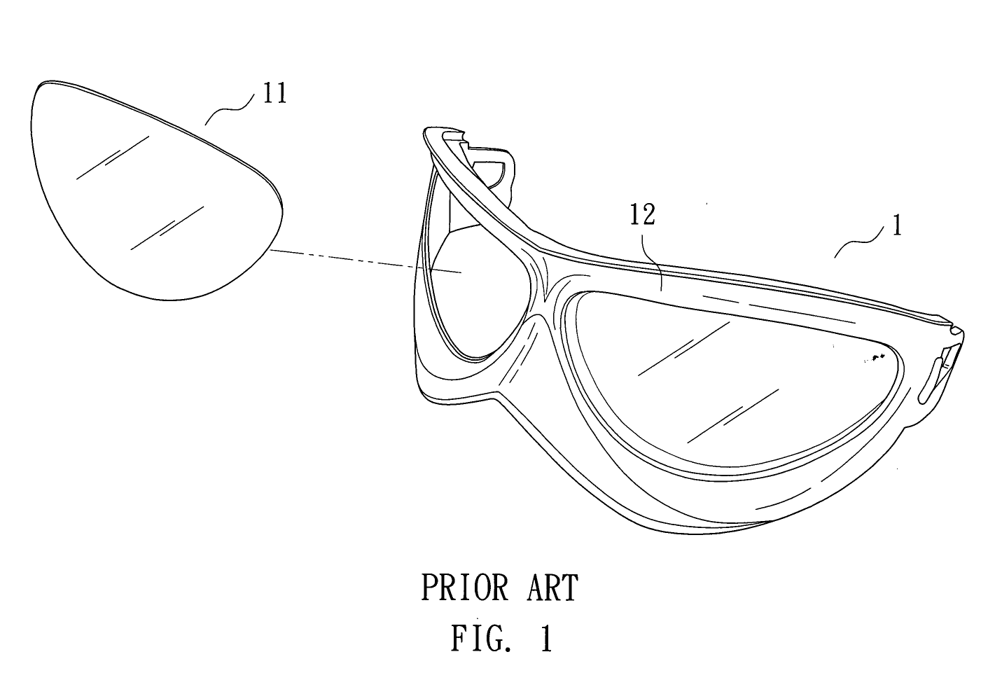

FIG. 2 is a perspective view illustrating an example of a lens/frame combination for a pair of glasses in accordance with the present invention.

FIG. 3 is a front view of the lens/frame combination in FIG. 2.

FIG. 4 is a front view illustrating another example of the lens/frame combination for a pair of glasses in accordance with the present invention.

### DETAILED DESCRIPTION OF THE PREFERRED EMBODIMENTS

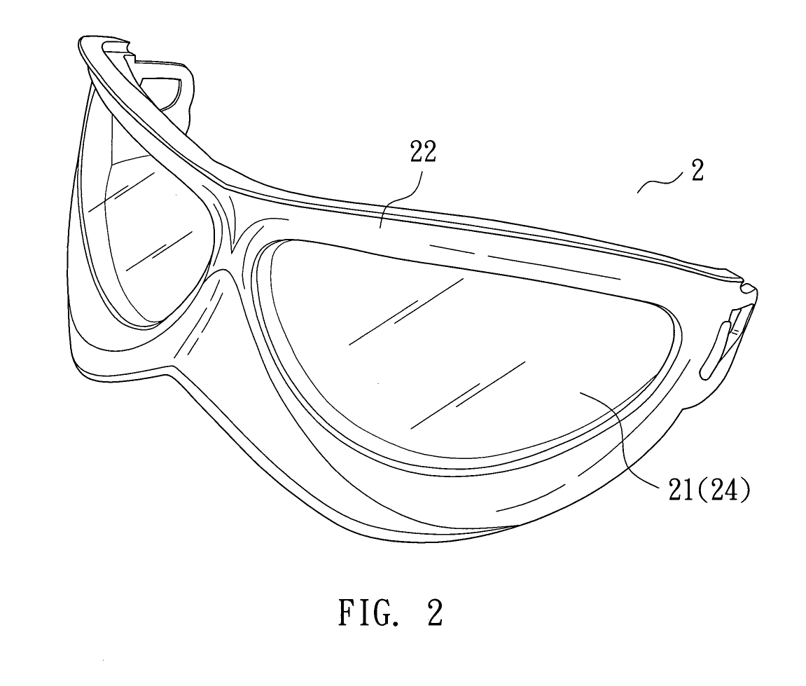

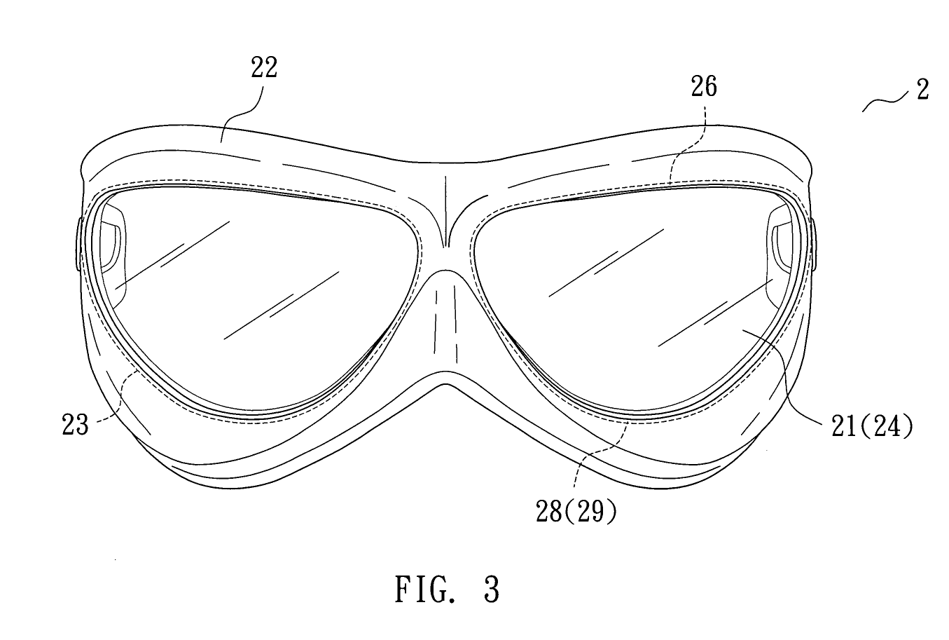

FIGS. 2 and 3 illustrate an example of a lens/frame combination 2 for a pair of glasses in accordance with the present invention. The lens/frame combination 2 includes a frame 22 and at least one lens 21 (two lenses 21 in this example). The frame 22 is made of a material different from that of the lenses 21. Each lens 21 includes a peripheral edge 29, and the frame 22 includes two receiving portions 24 for holding the lens 21. The peripheral edge 29 of the each lens 21 is integrally formed with the frame 22, forming a jointing area 23. For example, the lenses 21 can be placed in a mold, and molten material of the frame 22 is then injected into the mold. The frame 22 takes shape after cooling and hardening of the molten material. The frame 22 thus formed includes two receiving portions 24 each having a perimeter wall 26. A coupling groove 28 is defined in the perimeter wall 26 of each receiving portion 24. The peripheral edge 29 of each lens 21 is received in an associated coupling groove 28 of the frame 22 to a depth of 0.7 mm-5.0 mm, preferably 0.9 mm-3.5 mm.

In the lens/frame combination 2 thus formed, the lenses 21 are securely bonded with the frame 22, providing reliable engagement and preventing the lenses 21 from disengaging from the frame 22. Furthermore, the engaging depth between the peripheral edge 29 of each lens 21 and the associated coupling groove 28 of the frame 22 is not deep such that the material cost of the lenses 21 can be cut and that the frame 22 will not be too stiff, providing comfortable contact with the user's face.

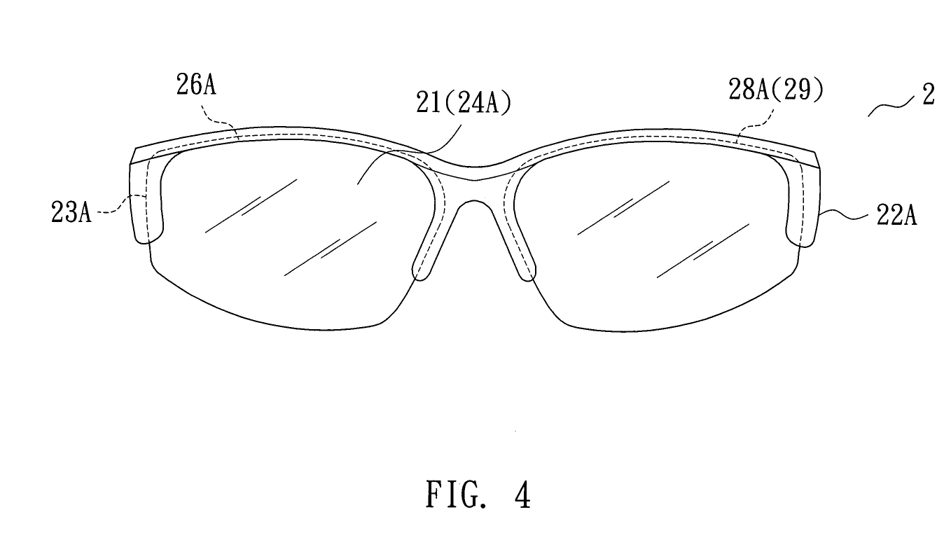

FIG. 4 illustrates another example of a lens/frame combination 2 for a pair of glasses in accordance with the present invention. The lens/frame combination 2 includes a frame 22A and at least one lens 21 (two lenses 21 in this example). The frame 22A is made of a material different from that of the lenses 21. Each lens 21 includes a peripheral edge 29, and the frame 22A includes two receiving portions 24A for holding the lens 21. The peripheral edge 29 of the each lens 21 is partially and integrally formed with the frame 22A, forming a jointing area 23A. The receiving portions 24A are engaged with upper portions of the peripheral edge 29 of the lenses 21. For example, the lenses 21 can be placed in a mold, and molten material of the frame 22A is then injected into the mold. The frame 22A takes shape after cooling and hardening of the molten material. The frame 22A thus formed includes two receiving portions 24A each having a perimeter wall 26A. A coupling groove 28A is defined in the perimeter wall 26A of each receiving portion 24A. The peripheral edge 29 of each lens 21 is received in an associated coupling groove 28A of the frame 22A to a depth of 0.7 mm-5.0 mm, preferably 0.9 mm-3.5 mm.

In the lens/frame combination 2 thus formed, the lenses 21 are securely bonded with the frame 22A, providing reliable engagement and preventing the lenses 21 from disengaging from the frame 22A. Furthermore, the engaging depth between the peripheral edge 29 of each lens 21 and the associated coupling groove 28A of the frame 22A is not deep such that the material cost of the lenses 21 can be cut and that the frame 22A will not be too stiff, providing comfortable contact with the user's face.

Although specific embodiments have been illustrated and described, numerous modifications and variations are still possible without departing from the teachings of the invention. The scope of the invention is limited by the accompanying claims.

What is claimed is:

1. A lens/frame combination for a pair of glasses, the lens/frame combination comprising a frame and at least one lens made of a material different from that of the frame, the frame including at least one receiving portion having a coupling groove for coupling with said at least one lens, said at least one lens including a peripheral edge that is at least partially and securely coupled with the coupling groove of the frame, forming a jointing area therebetween, the peripheral edge of said at least one lens being received in the coupling groove of said at least one receiving portion to a depth of 0.7 mm-5.0 mm.

2. The lens/frame combination for a pair of glasses as claimed in claim 1 wherein the peripheral edge of said at least one lens is completely coupled with the coupling groove of said at least one receiving portion of the frame.

3. The lens/frame combination for a pair of glasses as claimed in claim 1 wherein the peripheral edge of said at least one lens includes an upper portion coupled with the coupling groove of said at least one receiving portion of the frame.

4. The lens/frame combination for a pair of glasses as claimed in claim 1 wherein the peripheral edge of said at least one lens being received in the coupling groove of said at least one receiving portion to a depth of 0.9 mm-3.5 mm.
